(19) United States
(12) Patent Application Publication
(10) Pub. No.: US 2021/0286128 A1
(43) Pub. Date: Sep. 16, 2021

(54) REALIZING HIGH PER-MODE OPTICAL POWER WITH INTEGRATED LIGHT SOURCES AND OPTICAL COMBINERS

(71) Applicant: Lightmatter, Inc., Boston, MA (US)

(72) Inventor: Nicholas C. Harris, Jamaica Plain, MA (US)

(73) Assignee: Lightmatter, Inc., Boston, MA (US)

(21) Appl. No.: 17/202,300

(22) Filed: Mar. 15, 2021

Related U.S. Application Data
(60) Provisional application No. 62/990,297, filed on Mar. 16, 2020.

(51) Int. Cl. G02B 6/12

(52) U.S. Cl. CPC G02B 6/12014; G02B 6/12004; G02B 6/12033; G02B 2006/12152; G02B 2006/12123; G02B 2006/12135; G02B 2006/12138; G02B 2006/12121

(57) ABSTRACT

Optical chips and packages are described. The optical chips and packages described herein are configured to output high-power, single mode optical outputs for use by integrated photonics packages. Some embodiments relate to an optical chip or package including a light source array configured to output a plurality of first optical signals and an optical combiner configured to receive the plurality of first optical signals from the light source array and to output a second optical signal that is a combination of the received plurality of first optical signals. The optical combiner may include at least one tunable element configured to increase an optical power of the output second optical signal.

### RELATED APPLICATIONS

This application claims priority under 35 § USC 119(e) to U.S. Provisional Patent Application Ser. No. 62/990,297, filed Mar. 16, 2020, entitled “REALIZING HIGH PER-MODE OPTICAL POWER WITH INTEGRATED LASERS AND COMBINERS,” under Attorney Docket No. L0858.70027US00, which is hereby incorporated herein by reference in its entirety.

### BACKGROUND

A photonic integrated circuit is a device that integrates photonic functions in a single platform in a manner similar to how electronic integrated circuits integrate multiple electronic circuits onto a single integrated chip (IC). Photonic integrated circuits, however, use light rather than electricity to carry data at light speed with minimal loss and have applications in areas such as telecommunication, biomedical devices, and optical computing.

### BRIEF SUMMARY

Some embodiments are directed to an optical chip. The optical chip comprises a light source array configured to output a plurality of first optical signals and an optical combiner configured to receive the plurality of first optical signals from the light source array and to output a second optical signal that is a combination of the received plurality of first optical signals. The optical combiner comprises at least one tunable element configured to increase an optical power of the output second optical signal.

In some embodiments, the optical chip further comprises control electronics coupled to the at least one tunable element. In some embodiments, the control electronics comprise at least one of a transistor, converter, amplifier and/or one of a digital and/or analog logic element.

In some embodiments, the at least one tunable element comprises a phase shifter.

In some embodiments, the optical combiner includes at least one Mach-Zehnder interferometer, ring resonator, disk resonator, or photonic crystal cavity.

In some embodiments, a first signal of the plurality of first optical signals has a different optical mode than a second signal of the plurality of optical signals. In some embodiments, the second optical signal has a single optical mode.

In some embodiments, the second optical signal has a larger optical power than any one signal of the received plurality of first optical signals. In some embodiments, the second optical signal has an optical power that is approximately equal to a sum of the optical powers of the received plurality of first optical signals.

In some embodiments, the light source array comprises a plurality of light sources, the light sources of the plurality of light sources comprising diode lasers or vertical-cavity surface emitting lasers (VCSELs).

In some embodiments, the optical chip further comprises an optical communication port configured to output the second optical signal. In some embodiments, the optical communication port comprises one of optical fibers or grating couplers.

In some embodiments, the optical chip further comprises one or more substrates supporting the light source array and the optical combiner.

In some embodiments, the optical chip further comprises at least one temperature sensor thermally coupled to the one or more substrates.

Some embodiments are directed to an optical package. The optical package comprises an optical chip. The optical chip comprises a light source array configured to output a plurality of first optical signals; and an optical combiner configured to receive the plurality of first optical signals from the light source array and to output a second optical signal that is a combination of the received plurality of first optical signals. The optical combiner comprises at least one tunable element configured to increase an optical power of the output second optical signal. The optical package further comprises one or more substrates supporting the light source array and the optical combiner; and connection members disposed on the one or more substrates, the connection members configured to attach the optical package to a printed circuit board.

In some embodiments, the optical package further comprises control electronics coupled to the at least one tunable element. In some embodiments, the control electronics comprise at least one of a transistor, converter, amplifier and/or one of a digital and/or analog logic element.

In some embodiments, the at least one tunable element comprises a phase shifter.

In some embodiments, the optical combiner includes at least one Mach-Zehnder interferometer, ring resonator, disk resonator, or photonic crystal cavity.

In some embodiments, a first signal of the plurality of first optical signals has a different optical mode than a second signal of the plurality of optical signals. In some embodiments, the second optical signal has a single optical mode.

In some embodiments, the second optical signal has a larger optical power than any one signal of the received plurality of first optical signals. In some embodiments, the second optical signal has an optical power that is approximately equal to a sum of the optical powers of the received plurality of first optical signals.

In some embodiments, the light source array comprises a plurality of light sources, the light sources of the plurality of light sources comprising diode lasers or vertical-cavity surface emitting lasers (VCSELs).

In some embodiments, the optical package further comprises an optical communication port configured to output the second optical signal. In some embodiments, the optical communication port comprises one of optical fibers or grating couplers.

In some embodiments, the optical package further comprises at least one temperature sensor thermally coupled to the one or more substrates.

In some embodiments, the optical package further comprises a thermal exchange device coupled to the one or more substrates, the thermal exchange device configured to remove heat from the optical chip. In some embodiments, the thermal exchange device comprises one of a heat sink, a fan, or a fluid cooling device.

In some embodiments, the optical package further comprises a printed circuit board, the optical chip being attached to the printed circuit board by the connection members.

Some embodiments are directed to a method of manufacturing an optical chip. The method comprises forming a light source array on one or more substrates, the light source array configured to output a plurality of first optical signals; and forming an optical combiner on the one or more substrates, the optical combiner configured to receive the plurality of first optical signals from the light source array and to output a second optical signal that is a combination of the received plurality of first optical signals, wherein the optical combiner comprises at least one tunable element configured to increase an optical power of the output second optical signal. In some embodiments, the method further comprises forming control electronics on the one or more substrates, the control electronics coupled to the at least one tunable element.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic diagram of an optical chip, in accordance with some embodiments of the technology described herein.

FIG. 2A is a schematic diagram of components of the optical chip of FIG. 1, in accordance with some embodiments of the technology described herein.

FIG. 2B is a plot illustrating the transmission coefficient of an optical combiner when no voltage is applied, in accordance with some embodiments of the technology described herein.

FIG. 2C is a plot illustrating the transmission coefficient of an optical combiner when driven at a certain voltage, in accordance with some embodiments of the technology described herein.

FIG. 3A is a schematic diagram of an example of an optical combiner including a plurality of Mach-Zehnder interferometers (MZIs), in accordance with some embodiments of the technology described herein.

FIG. 3B is a schematic diagram of components of the optical combiner of FIG. 3A, in accordance with some embodiments of the technology described herein.

FIG. 4A is a schematic diagram of another example of an optical combiner including a plurality of resonators, in accordance with some embodiments of the technology described herein.

FIG. 4B is a schematic diagram of a components of the optical combiner of FIG. 4A, in accordance with some embodiments of the technology described herein.

FIG. 5 is a schematic diagram of an optical package including the optical chip of FIG. 1, in accordance with some embodiments of the technology described herein.

FIG. 6 is a schematic diagram of an optical system including the optical package of FIG. 5 coupled to external integrated photonic packages, in accordance with some embodiments of the technology described herein.

FIG. 7 is a flowchart illustrating a process 700 of manufacturing an optical chip, in accordance with some embodiments of the technology described herein.

FIG. 8 is a schematic diagram of a photonic processor including an optical source, in accordance with some embodiments of the technology described herein.

### DETAILED DESCRIPTION

Described herein are techniques for realizing high power, single mode optical outputs using integrated light sources and optical combiners. Light sources can be arranged in arrays (e.g., on a chip substrate), and the multiple outputs of such a light source array can be optically coupled to an optical combiner. The optical combiner can be configured to output a combined, single mode optical signal based on the received optical signals from the light source array. The output single mode optical signal can be a combination (e.g., having a combined optical power) of the received outputs from the light source array.

The inventors have recognized that the operation of integrated photonics platforms can be improved by using light sources with a larger optical power (e.g., approximately 2-5 W). Conventional light sources for integrated photonics platforms, however, do not typically output such large optical power optical signals having a single optical mode. Integrated photonics platforms that may benefit from an improved light source include optical computation platforms, light detection and radar (LIDAR) sensing platforms, and/or data communication platforms. For example, such an improved light source could increase the signal-to-noise ratio (SNR) of an optical computation platform.

The inventors have further recognized that, instead of using a single light source to achieve a high-power, single mode optical output, optical signals from many light sources can be combined to achieve a high-power, single mode optical output. Accordingly, the inventors have developed optical chip and package designs having integrated light source arrays and optical combiners configured to output optical signals having a single mode and high optical power.

In some embodiments, the optical chip includes a light source array and an optical combiner. The light source array can include a number of light sources, each configured to output an optical signal. For example, the light sources may be diode lasers, III-V semiconductor lasers, quantum dot lasers, vertical-cavity surface emitting lasers (VCSELs), or any suitable light source configured to output coherent light. The light source array is therefore configured to output a plurality of optical signals, and the optical combiner is configured to receive the plurality of optical signals from the light source array. The optical combiner is configured to combine the received optical signals and output a second optical signal. The second optical signal is a combination of the received first optical signals (e.g., the second optical signal has an optical power that is a combination of the optical powers of the received first optical signals). In some embodiments, the optical combiner includes at least one tunable element. The tunable element is configured to increase an output optical power of the optical combiner (e.g., to increase the optical power of the second optical signal) based on a received control signal.

In some embodiments, the optical chip includes control electronics coupled to the at least one tunable element. The control electronics may be configured to generate a control signal to control the at least one tunable element. For example, the control signal may cause the tunable element to change one or more settings to increase an output optical power of the optical combiner. In some embodiments, the control electronics include at least one of a transistor, converter, amplifier, and/or one of a digital and/or analog logic element. For example, the control electronics may include a transistor such as a bipolar junction transistor (BJT), a metal-semiconductor field-effect transistor (MESFET), and/or any other suitable transistor. Alternatively or additionally, the control electronics may include a converter such as an analog-to-digital converter (ADC) and/or a digital-to-analog converter (DAC). Alternatively or additionally, the control electronics may include an amplifier such as a transimpedance amplifier and/or a low-noise amplifier.

In some embodiments, the optical combiner includes at least one of a Mach-Zehnder interferometer (MZI), a ring resonator, a disk resonator, or a photonic crystal cavity. In some embodiments, the at least one tunable element of the optical combiner comprises a phase shifter. A control signal may be used to change a parameter of operation of the phase shifter. For example, in some embodiments, the control signal may be used to change the refractive index of the phase shifter. As a result, the phase shifter may change an operating parameter of the tunable element in response to receiving the control signal, thereby changing a parameter of the output of the tunable element. For example, in some embodiments where the optical combiner is a ring resonator, the phase shifter may be used to change the resonant frequency of the ring resonator, thereby changing an output optical power of the tunable element.

In some embodiments, the light source array outputs a plurality of optical signals having different optical modes. For example, a first optical signal of the plurality of optical signals may have a different optical mode than a second optical signal of the plurality of optical signals. In some embodiments, the optical combiner outputs a second optical signal having a single optical mode. That is, the optical combiner may receive a plurality of optical signals having different optical modes and combines the received optical signals and outputs a second optical signal having a single optical mode. In some embodiments, the optical combiner outputs a second optical signal having a larger optical power than any one of the received first optical signals from the light source array. In some embodiments, the second optical signal has an optical power that is approximately equal to a sum of the optical powers of the received plurality of first optical signals.

In some embodiments, the optical chip includes an optical communication port configured to output the second optical signal. For example, the optical communication port may include optical fiber outputs or grating coupler outputs. Alternatively or additionally, the optical communication port may include free-space outputs (e.g., wherein waveguides terminate at one or more edges of the optical chip, sending the output optical signal into free-space transmission).

In some embodiments, the optical chip includes one or more substrates supporting the light source array, the optical combiner, and/or the control electronics. The light source array may be on a separate substrate from the optical combiner and/or the control electronics in some embodiments. Alternatively, the light source array may be on a same substrate as the optical combiner and/or the control electronics in some embodiments.

In some embodiments, the optical chip includes at least one temperature sensor thermally coupled to the one or more substrates. The at least one temperature sensor may monitor a temperature of the optical chip and/or components of the optical chip (e.g., the light source array and/or optical combiner).

In some embodiments, the optical chip is included as a part of an optical package. The optical package includes one or more substrates supporting the light source array and/or the optical combiner. The light source array may be on a separate substrate than the optical combiner, in some embodiments, or the light source array may be on a same substrate as the optical combiner. In some embodiments, the optical package includes connection members to attach the optical package to a printed circuit board. For example, the connection members may include solder bumps or pads forming a ball grid array, pin members forming a pin grid array, or any other suitable connection members configured to surface mount the optical package to a printed circuit board.

In some embodiments, the optical package includes a thermal exchange device coupled to the one or more substrates. The thermal exchange device is configured to remove heat from the optical chip (e.g., passively or in response to information received from the at least one temperature sensor). The thermal exchange device may include, for example, one of a heat sink, a fan, or a fluid cooling device.

In some embodiments, the optical package includes a printed circuit board (PCB). The optical package may be attached to the PCB by the connection members. In some embodiments, the control electronics may be disposed on the PCB and coupled to the at least one tunable element of the optical combiner through the connection members.

Following below are more detailed descriptions of various concepts related to, and embodiments of, optical chips and/or packages for realizing high power, single mode optical outputs. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

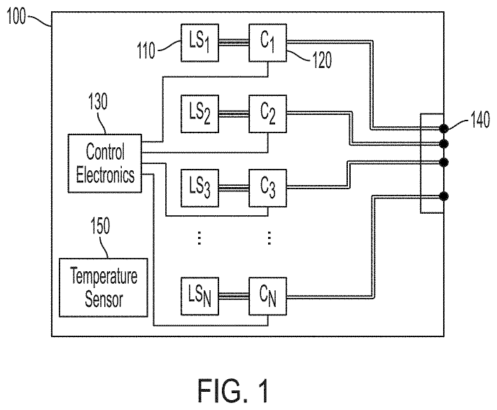

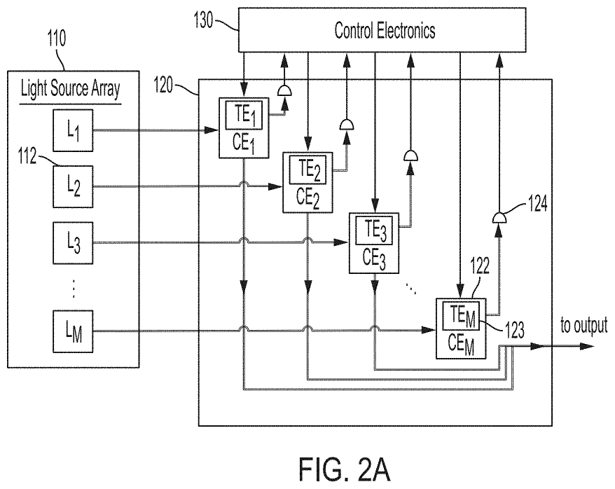

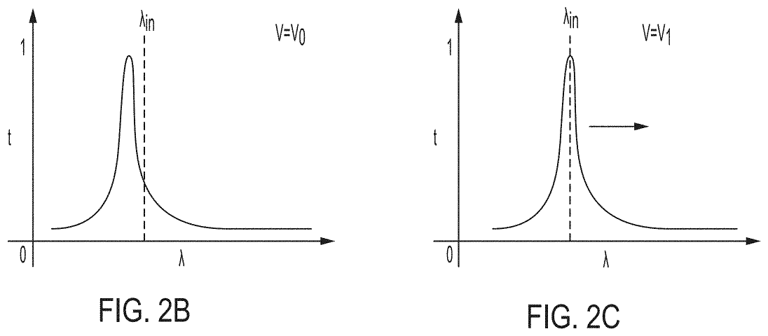

FIG. 1 is a schematic diagram of an optical chip 100, and FIG. 2A is a schematic diagram of components of the optical chip 100, in accordance with some embodiments of the technology described herein. The optical chip 100 includes light source arrays 110, optical combiners 120, control electronics 130, optical communication ports 140, and temperature sensor 150. In some embodiments, optical chip 100 may include additional or alternative components, or additional or alternative arrangement of components, not illustrated in the example of FIG. 1. In some embodiments, some or all of the components of FIG. 1 may be disposed on a same substrate (e.g., a semiconductor substrate, a silicon substrate, or any suitable substrate).

The light source array 110 may be implemented in a number of ways, including, for example, a plurality of light sources 112. In one example, the light source array 110 may include a plurality of light sources 112 configured to emit coherent light. Such light sources 112 may include any suitable type of laser (e.g., diode lasers, III-V semiconductor lasers, quantum dot lasers, vertical-cavity surface-emitting lasers (VCSELs), etc.). In another example, light source arrays 110 may include a plurality of light sources 112 configured to emit incoherent light. Such light sources 112 may include any suitable integrated light source (e.g., light-emitting diodes). In some embodiments, the plurality of light sources 112 may be heterogeneously integrated into a silicon photonics fabrication process. Alternatively, the optical chip, including the plurality of light sources 112 and/or optical combiners 120, could be realized in a III-V material platform (e.g., indium phosphide, gallium arsenide).

In some embodiments, the light sources 112 may be configured to emit light at multiple wavelengths λ₁, λ₂, λ₃, . . . , λ_{M}. The light sources 112 may be configured to emit multiple wavelengths λ₁, λ₂, λ₃, . . . , λ_{M} that are approximately equal to one another such that λ₁≈λ₂≈λ₃≈, . . . , ≈λ_{M}. In some embodiments, each of the light sources 112 may be configured to emit light at substantially the same wavelength such that λ₁=λ₂=λ₃=, . . . , =λ_{M}. In some embodiments, the wavelength of emission of light sources 112 may be in the visible, infrared (including near infrared, mid-infrared, and far infrared) or ultraviolet portion of the electromagnetic spectrum. In some embodiments, the wavelength of emission of light sources 112 may be in the O-band, C-band, or L-band.

In some embodiments, the light source array 110 is optically coupled to a corresponding optical combiner 120. The light source array 110 may be optically coupled to the optical combiner 120 using any suitable coupling technique. For example, outputs of the light source array 110 may be optically coupled to the inputs of the optical combiner using one or more waveguides (e.g., silicon photonic waveguides). Alternatively, in embodiments where the light source array 110 and optical combiner 120 are disposed on different substrates, the light source array 110 and optical combiner 120 may be optically coupled using any suitable technique to optically couple components disposed on separate substrates, including but not limited to grating coupling techniques and edge-coupling techniques.

In some embodiments, the optical combiner 120 is configured to receive multiple optical signals from a light source array 110 and output a single optical signal that is a combination of the received optical signals from the light source array 110. The optical signal that is output by the optical combiner 120 may have a greater optical power than any one of the received optical signals from the light source array 110. In some embodiments, the optical signal that is output by the optical combiner 120 may have an optical power that is approximately equal to a sum of the optical powers of the received optical signals from the light source array 110. For example, the received optical signals from the light source array 110 may each have an optical power of approximately 10 mW. For a light source array 110 having 10 light sources 112, the output optical power from the optical combiner 120 may then be approximately 100 mW, though it should be appreciated that the light source array 110 may include more than 10 or fewer than 10 light sources 112. In some embodiments, the output optical power from the optical combiner 120 may be less than or equal to 500 mW, in a range from 100 mW to 500 mW, in a range from 100 mW to 5 W, in a range from 500 mW to 5 W, or in any suitable range within those ranges.

In some embodiments, the optical combiner 120 is configured to receive multiple optical signals from the light source array 110, each received signal having a different optical mode. The optical combiner 120 is configured to output a single optical signal having a single optical mode. That is, the optical combiner 120 is configured to output a single mode, high-power optical signal.

In some embodiments, the optical combiner 120 includes modulators 122 and optical detectors 124. The modulators 122 are configured to receive light from a light source 112 of the light source array 110 and combine the received light into a single output light signal as described herein. In some embodiments, the modulators 122 may be any suitable optical modulator, including at least one of a Mach-Zehnder interferometer (MZI), a ring resonator, a disk resonator, or a photonic crystal cavity.

In some embodiments, the modulators 122 include one or more tunable elements 123. The tunable elements 123 may be configured to change the operation of the modulator 122 in response to receiving a control signal from control electronics 130. For example, the tunable elements 123 may be phase shifters configured to change an operating parameter of the modulators 122 (e.g., to increase an output optical power of the modulators 122) in response to an applied voltage signal.

FIGS. 2B and 2C are plots illustrating the transmission coefficient, t, of a modulator 122 based on the operation of tunable element 123. In the example of FIG. 2B, an initial voltage, V₀, has been applied to the tunable element 123 such that the peak of the transmission coefficient t occurs at a wavelength, λ, that is different than a wavelength, λᵢₙ, of the light signal received by the modulator 122 from the light source 112. In the example of FIG. 2C, a different voltage, V₁, is applied to the tunable element 123 such that the peak of the transmission coefficient, t, shifts towards larger wavelengths (e.g., a redshift) and approximately aligns with the received wavelength, λᵢₙ. In this manner, transmission of light through the modulator 122 is increased by applying a voltage signal V₁ to tunable element 123. It should be appreciated that in some embodiments, the applied voltage may cause the peak of the transmission coefficient to shift towards smaller wavelengths (e.g., a blueshift).

Returning to the description of FIGS. 1 and 2A, in some embodiments, the control electronics 130 may generate the control signal (e.g., the applied voltage) based on output received from optical detectors 124. Each optical detector 124 may be configured to receive an optical signal from a corresponding modulator 122, the optical signal carrying information indicative of the amount of light that is not transmitted through the modulator 122. The optical detectors 124 may convert an intensity of the received optical signal to an electrical signal that is sent to the control electronics 130. In some embodiments, the optical detectors 124 may be photodiodes, for example. In this manner, the optical detectors 124 provide feedback to the control electronics 130 about the transmission coefficient of the modulator 122, and the control electronics 130 may be configured to send a control signal to the tunable elements 123 based on the feedback received from the optical detectors 124.

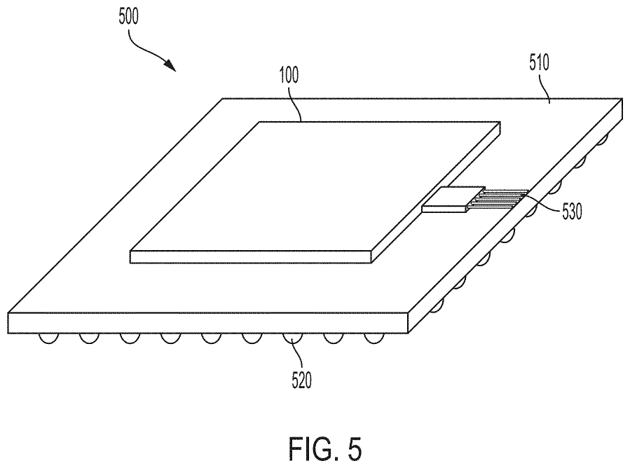

In some embodiments, the control electronics 130 may be disposed on a same substrate as the light source arrays 110 and the optical combiners 120, as shown in the example of FIG. 1. Alternatively, in some embodiments, the control electronics 130 may be disposed on a different substrate and/or, when optical chip 100 is integrated in a package, on a substrate supporting the package (e.g., substrate 510 as described in connection with the example of FIG. 5). In some embodiments, the control electronics may include one or more transistors. The transistors may be bipolar junction transistors (BJTs) and/or metal-semiconductor field-effect transistors (MESFETs), and/or any other suitable transistor. Alternatively or additionally, the control electronics may include converters, such as analog-to-digital converters (ADCs) and/or digital-to-analog converters (DACs). In some embodiments, the control electronics may include amplifiers (e.g., transimpedance amplifiers, low-noise amplifiers). In some embodiments, the control electronics may include digital and/or analog logic elements.

In some embodiments, the optical signals output by the optical combiners 120 may be output from optical chip 100 through optical communication ports 140. Optical communication ports 140 may include any suitable optical output components, including but not limited to optical fibers, grating couplers, and/or edge couplers.

In some embodiments, the optical chip 100 may include one or more temperature sensors 150 to monitor a temperature of the optical chip 100. Temperature fluctuations may cause output parameters of the light sources 112 to change (e.g., changing a wavelength of the output light signal) or may change the transmission properties of the modulators 122 (e.g., changing the wavelength associated with the maximum transmission coefficient). Temperature sensors 150 may provide information about such temperature fluctuations (e.g., to control electronics or to an external thermal management device) to maintain the operation parameters of optical chip 100.

In some embodiments, temperature sensors 150 may include any one of a suitable integrated temperature sensor, including but not limited to thermistors, thermocouples, resistance thermometers, silicon bandgap temperature sensors, and/or temperature transducers. In some embodiments, the temperature sensors 150 may be coupled to the one or more substrates of the optical chip 100. Alternatively or additionally, the temperature sensors 150 may be coupled to the light source arrays 110 and/or the optical combiners 120.

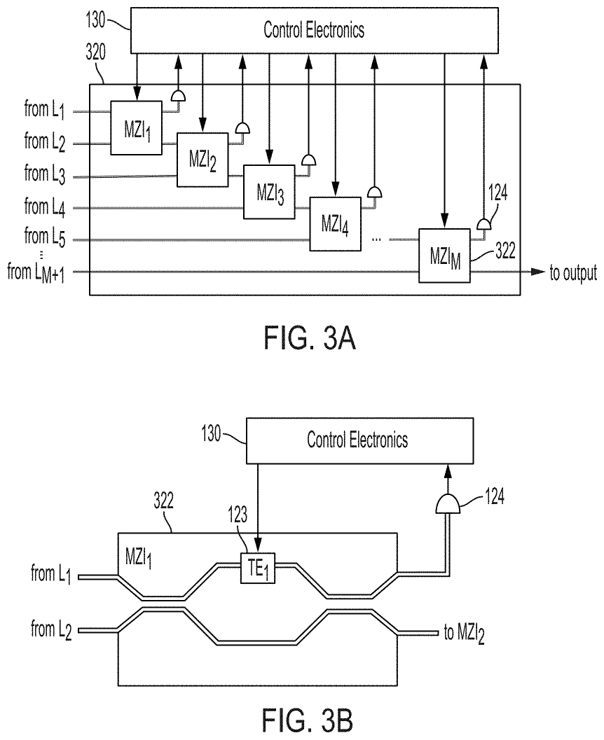

FIG. 3A is a schematic diagram of an example of an optical combiner 320 formed from a plurality of Mach-Zehnder interferometers (MZIs) 322, and FIG. 3B is a schematic diagram of an MZI 322 of optical combiner 320, in accordance with some embodiments of the technology described herein. It should be appreciated that optical combiner 320 may be used as optical combiner 120 in optical chip 100, as described in connection with the example of FIG. 1.

In some embodiments, optical combiner 320 includes a plurality of MZIs 322 arranged in a cascading array. A first MZI, MZI₁, receives light from light sources L₁ and L₂ of the light source array 110. MZI₁ outputs a combined optical signal (e.g., combining light from light sources L₁ and L₂) to MZI₂. MZI₂ receives the output of MZI₁ and an optical signal from light source L₃. MZI₂ then combines the received output of MZI₁ and the received light from light source L₃ and outputs this combined optical signal to MZI₃. This process of sequentially combining optical signals from light source array 110 continues until a single optical signal is output from MZI_{M}. The output of MZI_{M} is then output from the optical combiner 320 to the optical communications port 140 of the optical chip 100.

In some embodiments, each MZI 322 includes a tunable element 123, as shown in the example of FIG. 3B. The tunable element 123 modulates a phase in one arm of the MZI 322 in response to receiving a control signal (e.g., an applied voltage) from control electronics 130. Modulating the phase of the light in one arm adjusts the intensity of the output light by causing interference (e.g., constructive and/or destructive interference) between the two input optical signals. In this manner, an increased output optical power from MZI 322 may be achieved by modulating the phase of the light in one arm to cause constructive interference between the two input optical signals.

In some embodiments, an output of MZIs 322 may be received by optical detectors 124. Each optical detector 124 may be configured to receive an optical signal from a corresponding MZI 322, the optical signal carrying information indicative of the amount of light that is not transmitted through the MZI 322. In this manner, the optical detectors 124 provide feedback to the control electronics 130 about the transmission coefficient of the MZIs 322, and the control electronics 130 may be configured to send a control signal to the tunable elements 123 based on the feedback received from the optical detectors 124.

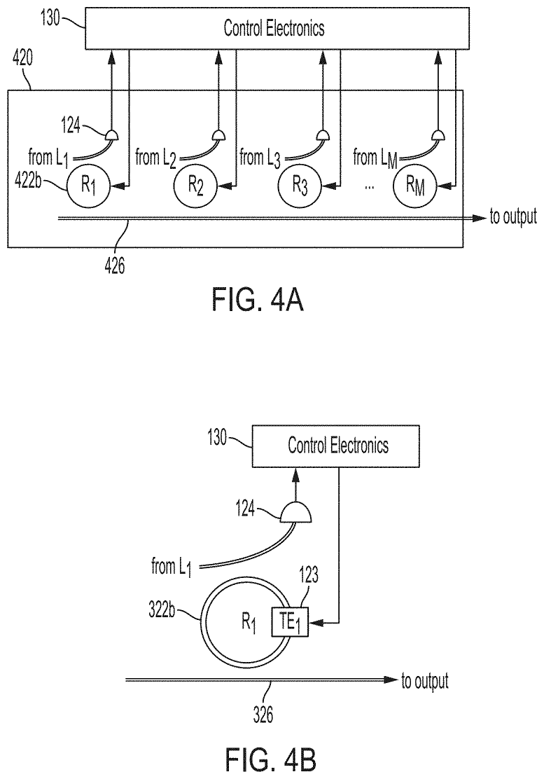

FIG. 4A is a schematic diagram of another example of an optical combiner 420 formed from a plurality of resonators 422, and FIG. 4B is a schematic diagram of a resonator 422, in accordance with some embodiments of the technology described herein. It should be appreciated that optical combiner 420 may be used as optical combiner 120 in optical chip 100, as described in connection with the example of FIG. 1.

In some embodiments, optical combiner 420 includes a plurality of resonators 422 arranged along a shared optical bus 426 (e.g., a photonic waveguide). The resonators 422 may be ring resonators, disk resonators, or any other suitable optical resonator. In some embodiments, each resonator 422 may be optically coupled to the optical bus 426. Upon receiving an optical signal from a corresponding light source 112 of the light source array 110, each resonator 422 may output another optical signal to the optical bus 426. The output optical signals from the resonators may then be combined in the optical bus 426.

In some embodiments, each resonator 422 includes a tunable element 123, as shown in the example of FIG. 4B. The tunable element 123 modulates a resonant frequency of the resonator 422 in response to receiving a control signal (e.g., an applied voltage) from control electronics 130. Modulating the resonant frequency of the resonator 422 adjusts the intensity of the output light from resonator 422. When the resonant frequency of the resonator 422 is closely matched to a frequency of the received light from the corresponding light source 112, the output optical power from the resonator 422 is maximized. In this manner, an increased output optical power from resonator 422 may be achieved.

In some embodiments, light received from the light source 112 that did not couple to the corresponding resonator 422 (e.g., because the resonant frequency of the resonator 422 did not match the frequency of the incoming light) may be received by optical detectors 124. The light received by optical detectors provides information indicative of the amount of light that is not transmitted through the resonator 422 to the optical bus 426. The optical detectors 124 then provide feedback about the transmission of light through resonators 422 in the form of an electrical signal to the control electronics 130. The control electronics 130 may then send a control signal to the tunable elements 123 based on the feedback received from the optical detectors 124.

FIG. 5 is a schematic diagram of an optical package 500, in accordance with some embodiments of the technology described herein. The optical package 500 includes optical chip 100 coupled to a substrate 510. The substrate 510 may be any suitable substrate, including an organic substrate, semiconductor substrate, or hybrid substrate. The substrate 510 includes connection members 520 configured to attach the optical package 500 to a printed circuit board (PCB). The optical package 500 also includes optical outputs 530 configured to output optical signals from the optical chip 100 to another chip and/or package.

In some embodiments, the connection members 520 include any suitable components configured to surface mount the optical package 500 to a PCB. For example, the connection members 520 may include solder bumps. In some embodiments, the solder bumps may be arranged in a ball grid array (BGA). Alternatively or additionally, the connection members 520 may include solder pads. Alternatively or additionally, the connection members 520 may include pins. In some embodiments, the pins may be arranged in a pin grid array (PGA).

Optical outputs 530 may comprise any suitable optical coupling components. The example of FIG. 5 shows optical outputs 530 drawn as optical fibers. However, it should be appreciated that optical coupling components may alternatively be configured as grating couplers and/or edge couplers.

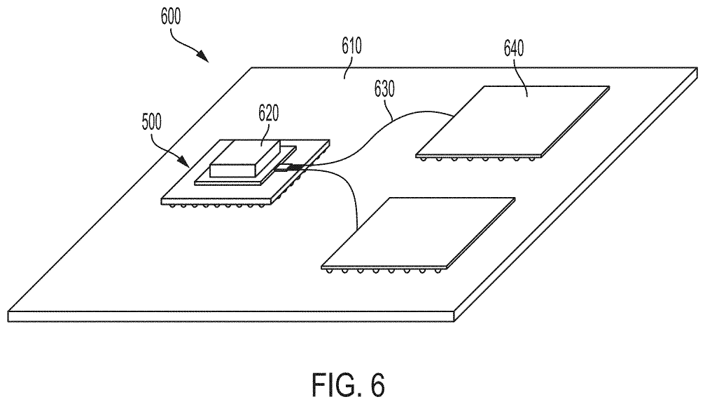

FIG. 6 is a schematic diagram of an optical system 600 including the optical package 500, in accordance with some embodiments of the technology described herein. The optical system 600 includes a substrate 610 supporting the optical package 500 and integrated photonics packages 640. The optical system also includes thermal exchange device 620 thermally coupled to the optical package 500 and integrated photonics packages 640 optically coupled through optical connections 630 to the optical outputs 530 of the optical package 500.

In some embodiments, the substrate 610 comprises a printed circuit board (PCB). The optical package 500 and/or the integrated photonics packages 640 may be surface mounted to the substrate 610 as described herein.

In some embodiments, the thermal exchange device 620 is configured to remove heat from the optical package 500. The thermal exchange device 620 may be a passive device, in some embodiments. For example, the thermal exchange device 620 may be a heat sink. Alternatively, in some embodiments the thermal exchange device 620 may be an active device. For example, the thermal exchange device 620 may be a fan or a fluid exchange device. In such embodiments, the thermal exchange device 620 may operate in response to feedback from temperature sensors 150 of optical chip 100.

In some embodiments, optical connections 630 may optically couple the optical package to external integrated photonics packages 640. As shown in the example of FIG. 6, optical connections 630 are illustrated as optical fibers. However, it should be appreciated that optical connections 630 may alternatively comprise free-space connections (e.g., via grating or edge couplers).

In some embodiments, integrated photonics packages 640 may receive the optical signals output by optical package 500. Integrated photonics packages 640 may use the received optical signals for any suitable purpose. For example, the integrated photonics packages 640 may be photonic computing packages, LIDAR packages, or any other suitable integrated photonic package.

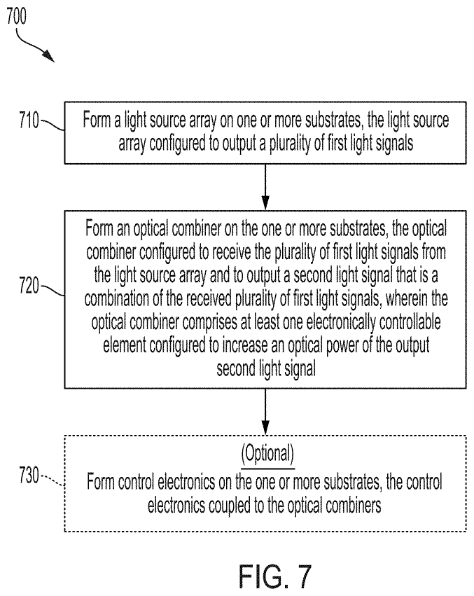

FIG. 7 is a flowchart illustrating a process 700 of manufacturing an optical chip (e.g, optical chip 100), in accordance with some embodiments of the technology described herein. In act 710, a light source array (e.g., light source array 110) may be formed on one or more substrates. The light source array may be configured to output a plurality of first optical signals. In some embodiments, the light source array may be formed on one or more substrates by, for example, coupling a pre-fabricated chip comprising light sources (e.g., light sources 112) to the one or more substrates of the optical chip. In some embodiments, the light source array may be formed on the one or more substrates by, for example, performing an integrated fabrication process (e.g., in a III-V material platform).

After act 710, the process 700 may proceed to act 720. In act 720, an optical combiner (e.g., optical combiner 120) may be formed on the one or more substrates. The optical combiner may be configured to receive the plurality of first optical signals from the light source array and to output a second optical signal that is a combination of the received plurality of first optical signals. The optical combiner may comprise at least one tunable element configured to increase an optical power of the output second optical signal. In some embodiments, the optical combiner may be optically coupled to the light source array by any suitable means, including but not limited to photonic waveguides, optical fibers, grating couplers, and/or edge couplers.

In some embodiments, forming the optical combiner may comprise performing an integrated fabrication process (e.g., in a III-V material platform). Alternatively, in some embodiments, forming the optical combiner may comprise performing a silicon fabrication process.

After act 720, the process 700 may proceed to optional act 730. In act 730, the process 700 may optionally include forming control electronics (e.g., control electronics 130) on the one or more substrates. In some embodiments, the control electronics may be coupled to the optical combiners (e.g., to provide a control signal to the tunable elements 123 of the optical combiners). In some embodiments, forming the control electronics may comprise forming at least one of transistors (e.g., BJTs, MESFETs, etc.), converters (e.g., ADCs, DACs), amplifiers (e.g., transimpedance amplifiers, low-noise amplifiers), and/or digital and/or analog logic elements.

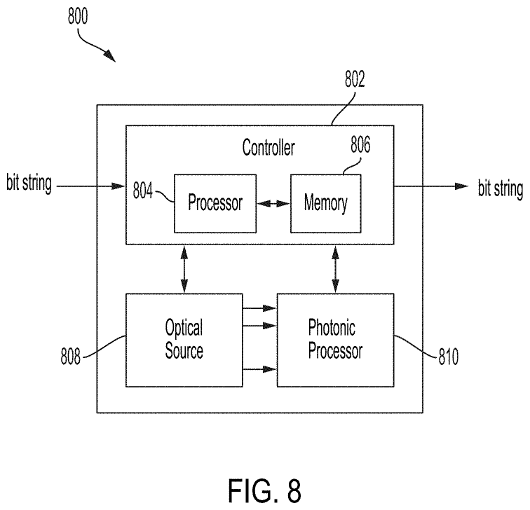

FIG. 8 is a schematic diagram of a photonic processing system 800 including an optical source 808, in accordance with some embodiments of the technology described herein. Photonic processing system 800 includes a controller 802, an optical source 808, and a photonic processor 810. It should be appreciated that the optical source 808 may be any optical source as described herein (e.g., optical chip 100, optical package 500). Alternatively or additionally, it should be appreciated that photonic processing system 800 may be configured as optical system 600, with optical package 500 serving as optical source 808 and photonic processor 810 serving as an integrated photonic package 640. In such embodiments, the controller 802 may be disposed on a same substrate (e.g., substrate 610) or on a separate substrate.

In some embodiments, the photonic processing system 800 receives, as an input from an external processor (e.g., a CPU), an input vector and/or matrix represented by a group of input bit strings and produces an output vector and/or matrix represented by a group of output bit strings. For example, if the input vector is an M-dimensional vector, the input vector may be represented by M separate bit strings, each bit string representing a respective component of the vector. Alternatively or additionally, for example, if an input matrix is an N×N matrix, the input matrix may be represented by N² separate bit strings, each bit string representing a respective component of the input matrix. The input bit string may be received as an electrical or optical signal from the external processor and the output bit string may be transmitted as an electrical or optical signal to the external processor.

In some embodiments, the controller 802 includes a processor 804 and a memory 806 for controlling the optical source 808 and/or photonic processor 810. The memory 806 may be used to store input and output bit strings and/or results from the photonic processor 810. The memory 806 may also store executable instructions that, when executed by the processor 804, control the optical source 808 and/or control components of the photonic processor 810 (e.g., encoders, phase shifters, and/or detectors). For example, the memory 806 may store executable instructions that cause the processor 804 to determine new input values to send to the photonic processor 810 based on the number of computational iterations that have occurred. Thus, the output matrix transmitted by the photonic processing system 800 to the external processor may be the result of multiple, accumulated multiplication operations, not simply a single multiplication operation. In another embodiment, the result of the computation by the photonic processing system 800 may be operated on digitally by the processor 804 before being stored in the memory 806. The operations on the bit strings may not be simply linear, but may also be non-linear or, more generally, be Turing complete.

The photonic processor 810 may perform matrix-vector, matrix-matrix, and/or tensor-tensor multiplication operations, in accordance with some embodiments of the technology described herein. In some embodiments, the photonic processor 810 includes two parts: modulators configured to encode elements of the input vector, matrix, and/or tensor in the amplitude and/or intensity of the optical signals from optical source 808, and optical detectors configured to detect and convert optical signals to an electrical signal proportional to a product of the encoded elements. The photonic processor 810 outputs these electrical signals to the controller 802 for further processing and/or output to the external processor.

In some embodiments, one or more of the input matrices or tensors may be too large to be encoded in the photonic processor using a single pass. In such situations, one portion of the large matrix may be encoded in the photonic processor and the multiplication process may be performed for that single portion of the large matrix and/or matrices. The results of that first operation may be stored in memory 806. Subsequently, a second portion of the large matrix may be encoded in the photonic processor and a second multiplication process may be performed. This “tiling” of the large matrix may continue until the multiplication process has been performed on all portions of the large matrix. The results of the multiple multiplication processes, which may be stored in memory 806, may then be combined to form a final result of the tensor multiplication operation.

In some embodiments, the photonic processor 810 may convert N separate optical pulses into electrical signals. In some embodiments, the intensity and/or phase of each of the optical pulses may be measured by optical detectors within the photonic processor 810. The electrical signals representing those measured values may then be electrically summed and/or output to the controller 802 for use in further computations and/or display.

Having thus described several aspects of at least one embodiment of this technology, it is to be appreciated that various alterations, modifications, and improvements will readily occur to those skilled in the art.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, examples of which are provided herein including with reference to FIG. 5. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. An optical chip comprising:
a light source array configured to output a plurality of first optical signals; and
an optical combiner configured to receive the plurality of first optical signals from the light source array and to output a second optical signal that is a combination of the received plurality of first optical signals,
wherein the optical combiner comprises at least one tunable element configured to increase an optical power of the output second optical signal.

2. The optical chip of claim 1, further comprising control electronics coupled to the at least one tunable element.

3. The optical chip of claim 2, wherein the control electronics comprise at least one of a transistor, converter, amplifier and/or one of a digital and/or analog logic element.

4. The optical chip of claim 2, wherein the at least one tunable element comprises a phase shifter.

5. The optical chip of claim 1, wherein the optical combiner includes at least one Mach-Zehnder interferometer, ring resonator, disk resonator, or photonic crystal cavity.

6. The optical chip of claim 1, wherein a first signal of the plurality of first optical signals has a different optical mode than a second signal of the plurality of optical signals.

7. The optical chip of claim 6, wherein the second optical signal has a single optical mode.

8. The optical chip of claim 1, wherein the second optical signal has a larger optical power than any one signal of the received plurality of first optical signals.

9. The optical chip of claim 1, wherein the second optical signal has an optical power that is approximately equal to a sum of the optical powers of the received plurality of first optical signals.

10. The optical chip of claim 1, wherein the light source array comprises a plurality of light sources, the light sources of the plurality of light sources comprising diode lasers or vertical-cavity surface emitting lasers (VCSELs).

11. The optical chip of claim 1, further comprising an optical communication port configured to output the second optical signal.

12. The optical chip of claim 11, wherein the optical communication port comprises one of optical fibers or grating couplers.

13. The optical chip of claim 1, further comprising one or more substrates supporting the light source array and the optical combiner.

14. The optical chip of claim 13, further comprising at least one temperature sensor thermally coupled to the one or more substrates.

15. An optical package, comprising:
an optical chip comprising:
a light source array configured to output a plurality of first optical signals; and
an optical combiner configured to receive the plurality of first optical signals from the light source array and to output a second optical signal that is a combination of the received plurality of first optical signals, wherein the optical combiner comprises at least one tunable element configured to increase an optical power of the output second optical signal;
one or more substrates supporting the light source array and the optical combiner; and
connection members disposed on the one or more substrates, the connection members configured to attach the optical package to a printed circuit board.

16. The optical package of claim 15, further comprising control electronics coupled to the at least one tunable element.

17. The optical package of claim 16, wherein the control electronics comprise at least one of a transistor, converter, amplifier and/or one of a digital and/or analog logic element.

18. The optical package of claim 15, wherein the at least one tunable element comprises a phase shifter.

19. The optical package of claim 15, wherein the optical combiner comprises one of a Mach-Zehnder interferometer, a ring resonator, a disk resonator, or a photonic crystal cavity.

20. The optical package of claim 15, further comprising a thermal exchange device coupled to the one or more substrates, the thermal exchange device configured to remove heat from the optical chip.

21. The optical package of claim 20, wherein the thermal exchange device comprises one of a heat sink, a fan, or a fluid cooling device.

22. The optical package of claim 15, further comprising a printed circuit board, the optical chip being attached to the printed circuit board by the connection members.

23. A method of manufacturing an optical chip, the method comprising:
forming a light source array on one or more substrates, the light source array configured to output a plurality of first optical signals; and
forming an optical combiner on the one or more substrates, the optical combiner configured to receive the plurality of first optical signals from the light source array and to output a second optical signal that is a combination of the received plurality of first optical signals, wherein the optical combiner comprises at least one tunable element configured to increase an optical power of the output second optical signal.

24. The method of claim 23, further comprising:
forming control electronics on the one or more substrates, the control electronics coupled to the at least one tunable element.
